(19) United States
(12) Patent Application Publication
(10) Pub. No.: US 2002/0139277 A1
(43) Pub. Date: Oct. 3, 2002

(54) Paint ink composition and drawing implement

(75) Inventor: Hitoshi Ogata, Tokyo (JP)

Correspondence Address: OSTROLENK FABER GERB & SOFFEN, 1180 AVENUE OF THE AMERICAS, NEW YORK, NY, 100368403

(73) Assignee: Marvy Co., Ltd.

(21) Appl. No.: 10/107,638

(22) Filed: Mar. 25, 2002

(30) Foreign Application Priority Data
Mar. 27, 2001 (JP) 2001-090643

(51) Int. Cl. C09D 11/12

(52) U.S. Cl. 106/31.3; 106/31.62

(57) ABSTRACT

The present invention provides a paint ink composition that does not require any special additives, that is designed so that only the paint ink portion burns off and does not remain when the candle is lit, and which enables three-dimensional expression in drawn (coated) areas. The present invention further provides a drawing implement that enables direct coating of this paint ink composition. The paint ink composition employs paraffin as a binder. A paint ink composition containing paraffin in the amount of 10 to 70 parts by weight, a volatile solvent in the amount of 10 to 70 parts by weight, a thickener and/or gelling agent in the amount of 0.1 to 30 parts by weight, and a dye and/or pigment, is desirable.

### BACKGROUND OF THE INVENTION

1. Field of the Invention

The present invention relates to a paint ink composition that is suitable for the application of designs and the like to candles in particular, and to a drawing implement with which the paint ink composition can be applied directly to a candle.

2. Description of Related Art

Poster colors, oil paints, acrylic paints, and the like have hitherto been used as paint inks for drawing on candles. These poster colors, paints and other such paint inks are normally used with specific and special additives being added in order to improve fixation of the inks to the surface of the candle and in order to prevent the inks from being repelled.

However, such conventional paint inks are unsatisfactory because it is difficult to reduce costs due to the special additives that must be used in order to improve fixation and prevent repelling, and because the paint ink portion remains after the candle is burned.

In addition, it is difficult to express the area in which drawing has been performed in three dimensions using such conventional paint inks, further contributing to dissatisfaction with these products.

### BRIEF SUMMARY OF THE INVENTION

The present invention was conceived in view of the above-described circumstances and has as its objective the provision of a paint ink composition that does not require specific additives, in which the paint ink portion does not remain following burning of the candle, and which enables a drawn (coated) area to be expressed three-dimensionally. It is a further objective of the present invention to provide a drawing implement that can directly apply this paint ink composition.

In a paint ink composition according to the present invention, a paraffin is employed as a binder so as to solve the above problems.

This composition demonstrates excellent fixation to candles when a candle is the particular object to be decorated. Accordingly, as it is not necessary to use special additives to improve fixation or prevent repelling, costs can be reduced as compared to conventional paint ink compositions.

In addition, when employing this paint ink composition to decorate a candle with pictures or characters, the paint ink components other than the pigment are burned along with the candle. As a result, there is no burnt gas from components other than the pigment remaining, and no odor other than that of the candle. Accordingly, decoration of the candle can be carried out freely without concern that the user's enjoyment of the candle will be impaired.

Further, if the paint ink composition is formulated to have thixotropy, the thixotropy can prevent dripping of the coated composition as a result. Accordingly, when drawing pictures or characters on the object to be decorated, the paint ink composition can be thickly coated to enable three-dimensional expression or a decoration that appears three-dimensional.

The drawing implement according to the present invention is provided with a container filled with the above-described paint ink compositions. Thus, the paint ink composition can be directly applied (to draw a design) to the surface of an object to be decorated (on which a design will be drawn), such as a candle, by discharging this paint ink composition from the opening of the container, enabling decorations using pictures or characters to be freely executed.

### BRIEF DESCRIPTION OF THE DRAWING

FIG. 1 is a cross-sectional view of a main portion in an example of the drawing implement according to the present invention.

### DETAILED DESCRIPTION OF THE INVENTION

The paint ink composition according to the present invention will now be explained in detail.

This paint ink composition is optimally employed for applying a design or writing characters on the surface of candles in particular, and contains paraffin, a volatile solvent, thickener and/or various types of gelling agents, and dyes and/or pigments.

In the paint ink composition according to the present invention, paraffin serves as a binder for coloring materials consisting of dyes or pigments, and is the main component of the composition. In other words, the amount of the paraffin to be incorporated is such that the paraffin accounts for a major portion of those components other than the volatile solvents, i.e., those components which remain after the volatile solvent is evaporated. Specifically, paraffin is included in an amount falling within the range of 10 parts by weight or more to 70 parts by weight or less of the total weight including the volatile solvent. Like the paraffin employed in regular candles, paraffin having a melting point of around 30° C. to 100° C. is optimally employed in the present invention. Note that paraffin with this type of melting point has a carbon number on the order of 15 to 50.

In addition, a paraffin which has been rendered into an emulsion by emulsifying in a solvent, or a paraffin which has been dissolved in a solvent is suitably employed, with the paraffin formulated into this form and then incorporated into the composition. Water, alcohol or turpentine oil are optimally employed as the solvent used to emulsify or dissolve the paraffin. Commercially available paraffin emulsions that are optimally employed include Selosol 651-A, Selosol 732-B, Selosol 716, Selosol 428, Selosol B-460, Selosol B-608, Selosol B-982, and Selosol-686 (manufactured by Chukyo Yushi Co., Ltd.), among others.

The volatile solvent is to maintain the composition in a liquid state (emulsion state) without the paraffin, etc., hardening. Specifically, this volatile solvent is included in an amount that is 10 parts by weight or more to 70 parts by weight or less of the total weight of the composition. Water, such as ion exchange water, is particularly favorably employed as this volatile solvent due to its low cost and convenience. However, an ethyl alcohol aqueous solution may also be used.

The thickener and various gelling agents are not particularly restricted, examples of suitably employed materials including Thixol T-800 (a polymer activator-type thickener (Toshin Chemical Co., Ltd.)), OPTIFLO H (a non-urethane association thickener (Toshin Chemical Co., Ltd.)), OPTIFLO L (a non-urethane association thickener (Toshin Chemical Co., Ltd.)), OPTIFLO M (Toshin Chemical Co., Ltd.), ASE60 (an acrylic thickener (PRIMAL distributed by Sanyo Trading Co., Ltd.)), hydroxyethyl cellulose, xanthene gum, and the like. Of these, ASE60 is optimally employed. Note that acrylic and cellulose derivatives are suitably employed as the thickener.

This type of thickener or gelling agent is employed to adjust the viscosity of the paint ink composition of the present invention. Specifically, the viscosity of paint ink composition of the present invention is adjusted to be in the range of 1000 cP to 20000 cP. When the viscosity is less than 1000 cP, overly high flowability results, which tends to enhance the propensity for the material to flow off the surface of the candle when a design is drawn thereon with this material (when this material is coated thereto), as will be described below. On the other hand, when the viscosity exceeds 20000 cP, flowability deteriorates excessively, so that drawing (coating) becomes difficult. To adjust the viscosity into the aforementioned range, the thickener and the gelling agent are added in an amount which is 0.01 parts by weight or more to 30 parts by weight or less of the total weight of the composition (note that in the case where a plurality of thickeners and gelling agents are used, the aforementioned values are the total values for these components).

It is desirable to provide thixotropy to the ink composition of the present invention, rather than to simply adjust the viscosity into the aforementioned range. To provide thixotropy, an acrylic emulsion type thickener (ASE 60 for example) is added as the aforementioned thickener or gelling agent. Providing thixotropy to the paint ink composition by using an acrylic emulsion thickener is performed as follows. Namely, an alkaline solution such as triethanolamine or the like is added to a dispersion or solution containing the aforementioned paraffin, to adjust it to a weakly alkaline pH of around 9. The thickener is then added. Thixotropy is provided to the paint ink composition that is ultimately obtained concurrent with the thickening that takes place from the addition of the thickener.

Conventionally known agents such as organic pigments, inorganic pigments, various dyes, pearl pigments, metal powders, glass flakes and the like may be employed as the dye or pigment used as the coloring agent in the present invention. One or a plurality of these agents may be suitably selected depending on the desired color. In addition, the amount of the dye and/or pigment included can be suitably determined according to the type of agent employed.

Mildew-proofing agents, antifoaming agents and the like may be used as compounding agents in addition to those mentioned above. Suitably employed mildew-proofing agents include SLAOFF 72N (Watanabe Chemical Co., Ltd.) and BIOTACK (Toshin Chemical Co., Ltd.), among others. Suitably employed antifoaming agents include ADEKANATE B748A (Yoko Industries Co., Ltd.) and AQUALENE 8020 (Toshin Chemical Co., Ltd.), among others. While not particularly restricted, the amount in which these mildew-proofing and antifoaming agents are included is 0.1 parts by weight respectively.

When used as candle paint for decorating a candle, a paint ink composition of this composition has the following superior effects in particular.

Namely, since paraffin which is the same as that employed in ordinary candles is the main component remaining after the volatile components have been removed, this paint ink composition demonstrates excellent fixation to the candle. Accordingly, there is no need to use special additives for improving fixation or preventing repelling. Thus, costs can be reduced as compared to conventional compositions for this purpose.

In addition, in the case where this paint ink composition is employed to apply decorations such as pictures or characters onto the candle, the paint ink composition burns along with the candle when the candle is burned. As a result, no burnt gases remain, nor is an odor generated which is different from that of the candle. Thus, decoration can be made to the candle without concern that the user's enjoyment of the candle will be impaired.

The paint ink composition according to the present invention is not limited to use in candle decoration (drawing a design onto the candle). Rather, this composition may also be used to decorate paper, cloth, wood, metal, ceramics, plastics and the like. In this case, since the paint ink composition employs paraffin as the main component excluding the volatile agents, it demonstrates excellent fixation to the material to be decorated (on which a design is drawn).

Further, in the case where the composition has been formulated to have thixotropy, it is possible to prevent the coated composition from dripping off. Accordingly, three-dimensional expression or decorations that appear three-dimensional can be achieved by thickly applying the composition when drawing a picture or character on the object to be decorated.

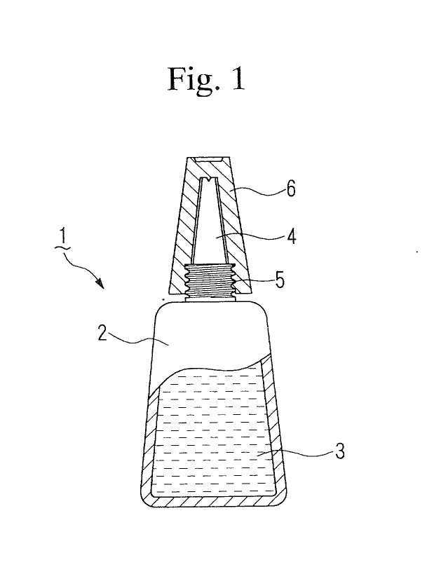

The drawing implement for enabling direct coating of this type of paint ink composition will now be explained. FIG. 1 is a diagram showing an example of the drawing implement for coating the paint ink composition. The numeral 1 in the figure indicates the drawing implement. This drawing implement 1 is filled with the paint ink composition 3 of the present invention inside a resin container 2. A resin discharge element 4 is provided to this opening. A thread portion 5 is formed to the opening of container 2. A cap 6 is attached in a releasable manner to container 2 by screwing onto thread portion 5.

In order to decorate by drawing using a drawing implement 1 of this design, the tip of resin discharge element 4 is suitably cut. As a result, when pressure is applied to container 2, the paint ink composition inside container 2 can be discharged from the end of cut discharge element 4. Accordingly, by pressing container 2 while suitably positioning and moving the tip of discharge element 4 on the candle or other such object to be decorated (on which a design will be drawn), the paint ink composition is directly coated to (a design is drawn onto) the surface to be decorated. Thus, decoration with pictures or characters can be freely performed.

In addition, three-dimensional expression can be achieved by thickly coating the paint ink composition, enabling decorations with a three-dimensional appearance.

Note that if a plurality of these drawing implements 1 are prepared in advance so as to have different colors therein, then decoration using not one but many colors can be performed. Accordingly, even more beautiful decoration can be carried out.

### EXAMPLES

The present invention will now be explained in greater detail using preferred embodiments thereof.

### Example 1

The paint ink composition according to the present invention was formulated in different colors by employing and uniformly mixing 88.3 parts by weight of Selosol 428 (Chukyo Yushi Co., Ltd.) as a paraffin emulsion in which paraffin was emulsified in a solvent, 0.1 parts by weight of BIOTACK (Toshin Chemical Co., Ltd.) as a mildew-proofing agent, 0.1 parts by weight of ADEKANATE B748A (Yoko Industries Co., Ltd.) as an antifoaming agent, 1.5 parts by weight of ASE60 (PRIMAL distributed by Sanyo Trading Co., Ltd.) as a thickener (gelling agent), 10.0 parts by weight of ion exchange water as a volatile solvent, and 1.0 part by weight in total of a pigment and/or dye as suitable for the color to be produced. Note that when mixing these components, the pH was adjusted to around 9 by adding triethanolamine as an alkali. A thickener was then added and mixed in to provide thixotropy to the obtained mixture (paint ink composition).

The viscosity of the paint ink compositions obtained in this way was checked using a viscometer. All of the colors had a viscosity in the range of 1000 to 20000 cP. A check of the dripping condition of the compositions showed almost no dripping for any of the colors, confirming that the compositions had sufficient thixotropy.

### Example 2

The paint ink composition according to the present invention was formulated in different colors by employing and uniformly mixing 84.8 parts by weight of Selosol 428 (Chukyo Yushi Co., Ltd.) as a paraffin emulsion in which paraffin was emulsified in a solvent, 0.1 parts by weight of BIOTACK (Toshin Chemical Co., Ltd.) as a mildew-proofing agent, 0.1 parts by weight of ADEKANATE B748A (Yoko Industries Co., Ltd.) as an antifoaming agent, 2.0 parts by weight of ASE60 (PRIMAL distributed by Sanyo Trading Co., Ltd.) as a thickener (gelling agent), 10.0 parts by weight of ion exchange water as a volatile solvent, and 3.0 parts by weight in total of a pigment and/or dye as suitable for the color to be produced. Note that when mixing these components, thixotropy was provided to the obtained mixture (paint ink composition) in the same manner as in Example 1.

The viscosity of the paint ink compositions obtained in this way was checked in the same manner as in Example 1. All of the colors had a viscosity in the range of 1000 to 20000 cP. A check of the dripping behavior of the compositions showed almost no dripping for any of the colors, confirming that sufficient thixotropy was present.

### Example 3

The paint ink composition according to the present invention was formulated in different colors by employing and uniformly mixing 85.8 parts by weight of Selosol 428 (Chukyo Yushi Co., Ltd.) as a paraffin emulsion in which paraffin was emulsified in a solvent, 0.1 parts by weight SLAOFF 72N (Watanabe Chemical Co., Ltd.) as a mildew-proofing agent, 0.1 parts by weight AQUALENE 8020 (Toshin Chemical Co., Ltd.) as an antifoaming agent, 3.0 parts by weight of Thixol T-800 (Toshin Chemical Co., Ltd.) as a thickener (gelling agent), 10.0 parts by weight of ion exchange water as a volatile solvent, and 1.0 parts by weight in total of a pigment and/or dye as suitable for the color to be produced. Note that unlike the preceding Examples 1 and 2, the pH was not adjusted when mixing these components, and viscosity adjustment was carried out alone without providing thixotropy by adding thickeners (gelling agents).

The viscosity of the paint ink compositions obtained in this way was checked in the same manner as in Example 1. A portion of the colors were found to have viscosities in excess of the range of 1000 to 20000 cP. A check of the dripping behavior of the compositions revealed that almost all of the colors dripped, making it clear that there was almost no thixotropy present.

### Example 4

The paint ink composition according to the present invention was formulated in different colors by employing and uniformly mixing 84.5 parts by weight of Selosol 428 (Chukyo Yushi Co., Ltd.) as a paraffin emulsion in which paraffin was emulsified in a solvent, 0.1 parts by weight of SLAOFF 72N (Watanabe Chemical Co., Ltd.) as a mildew-proofing agent, 0.1 parts by weight of AQUALENE 8020 (Toshin Chemical Co., Ltd.) as an antifoaming agent, 5.0 parts by weight of Thixol T-800 (Toshin Chemical Co., Ltd.) as a thickener (gelling agent), 10.0 parts by weight of ion exchange water as a volatile solvent, and 3.0 parts by weight in total of a pigment and/or dye as suitable for the color to be produced. Note that as in the preceding Example 3, the pH was not adjusted when mixing these components, with only viscosity adjustment carried out.

The viscosity of the paint ink compositions obtained in this way was checked in the same manner as in Example 1. A portion of the colors were found to have viscosities in excess of the range of 1000 to 20000 cP. A check of the dripping behavior of the compositions revealed that almost all of the colors dripped, making it clear that there was almost no thixotropy present.

The thus-obtained paint ink compositions from Examples 1 to 4 were used to fill containers 2 as shown in FIG. 1, and where then discharged from discharge elements 4. All four paint ink compositions demonstrated excellent flowability and were thus confirmed to have good properties for coating (drawing).

In addition, each of these paint ink compositions according to Examples 1 to 4 were coated to (a design was drawn onto) respective candles. The candles were then ignited and burned. No burnt gas, which arises from paint ink components other than pigments, remained, and no odor other than the odor when burning the candle, i.e., the odor when burning paraffin, was detected. Note also that the fixation of the paint ink compositions from each of the examples to the candles was extremely good.

The paint ink compositions according to Examples 1 through 4 were coated to paper, cloth, wood, metal, ceramic and plastic respectively. The paint ink composition had excellent fixation to each of these materials. It was therefore confirmed that the paint ink composition according to the present invention possessed excellent fixation even without employing special additives to improve fixation and prevent repelling.

The paint ink compositions according to Examples 1 through 4 were coated to (a design was drawn onto) respective candles, and in particular, were coated thickly to respective candles. The paint ink compositions according to Examples 1 and 2 demonstrated no dripping as a result of the compositions' thixotropic properties. Accordingly, a three-dimensional decoration was achieved by allowing the thickly coated compositions to harden as applied. In contrast, the paint ink compositions according to Examples 3 and 4 demonstrated a very small amount of dripping which was sufficient to prevent a thick decoration to be achieved as applied (drawn).

Judging comprehensively from the viscosity and operability of the paint ink compositions according to Examples 1 through 4, as well as from the results obtained in various tests conducted on the obtained paint ink compositions, it was deemed that the paint ink composition in Example 1 was most superior, followed in descending order of superiority by the paint ink compositions of Example 2, Example 3 and Example 4.

What is claimed is:

1. A paint ink composition comprising paraffin as a binder.

2. A paint ink composition according to claim 1, comprising:
paraffin in an amount of 10 to 70 parts by weight, a volatile solvent in an amount of 10 to 70 parts by weight, a thickener and/or gelling agent in an amount of 0.1 to 30 parts by weight, and a dye and/or pigment.

3. A paint ink composition according to claims 1 or 2, wherein the paraffin has a melting paint of 30° C. to 100° C., and is added to the composition in the form of an emulsion or solution in a solvent.

4. A paint ink composition according to claims 1 or 2, wherein the paraffin has a melting point of 30° C. to 100° C., and is added to the composition in the form of an emulsion or solution in a solvent, and the composition as a whole has a viscosity adjusted to 1000 to 20000 cP with the thickener and/or gelling agent.

5. A paint ink composition according to claims 1 or 2, wherein the paraffin has a melting point of 30° C. to 100° C., and is added to the composition in the form of an emulsion or solution in a solvent, and the composition as a whole has a viscosity adjusted to 1000 to 20000 cP with the thickener and/or gelling agent, and is provided with thixotropy.

6. A paint ink composition according to any one of claims 1 through 5, with is for use in a candle paint.

7. A drawing implement (1) comprising a container (2) containing a paint ink composition (3) as recited in any one of claims 1 through 6.

8. A drawing implement (1) according to claim 7 comprising a discharge element at the opening of the container (2), for discharging the paint ink composition (3) contained in the is container.
